(19) United States
(12) Patent Application Publication
(10) Pub. No.: US 2015/0118912 A1
(43) Pub. Date: Apr. 30, 2015

(54) CONNECTOR FOR FLAT CONDUCTOR

(71) Applicant: ARGOSY RESEARCH INC., Hsinchu (TW)

(72) Inventors: YU-TSAN LEE, Hsinchu (TW); LI-SHAN LIN, Hsinchu (TW)

(21) Appl. No.: 14/311,323

(22) Filed: Jun. 22, 2014

(30) Foreign Application Priority Data
Oct. 25, 2013 (TW) 102219879

(51) Int. Cl. H01R 12/77

(52) U.S. Cl. CPC H01R 12/774
USPC 439/635

(57) ABSTRACT

A connector for a flat conductor includes an insulation body, a plurality of conductive terminals disposed in the insulation body, a press over, an embedded metal unit, an embedded metal piece and two ground secure members. The embedded metal unit and the embedded metal piece are respectively embedded in the upper portion and the lower portion of the insulation body, and respectively in contact with the ground secure members thereby forming an electrical connection. Accordingly, the connection for a flat conductor provided by the present invention has advantages of providing an enhanced electrical interference prevention thereby being applicable for high-frequency transmission, and the strength of the insulation body is reinforced for preventing the occurrence of breaking

### BACKGROUND OF THE INVENTION

1. Field of the Invention

The present invention relates to a connector for a flat conductor, especially to a connector allowing a flexible printed circuit (FPC) or a flexible flat cable (FFC) to be inserted.

2. Description of Related Art

A flat conductor such as a flexible printed circuit (FPC) or a flexible flat cable (FFC) is a commonly-known conductor. A connector for the FPC/FFC often includes a press cover, a plastic body and terminals disposed in the plastic body, the plastic body allows the FPC/FFC to be inserted, so the FPC/FFC is enabled to be in contact with the terminals, and the press cover can be operated between an open or a close location, wherein the FPC/FFC is pressed when the press cover is at the close location.

However, with the faster transferring speed for high-frequency signal, the above-mentioned connector is designed to have a highly-compact arrangement, so the quantity of conductive terminals is large and the intervals in between become very small, thereby causing the connector being very likely to be interfered by electrical interference, such as electrostatic interference, electromagnetic wave interference, impedance matching, noise interference and crosstalk interference between adjacent terminals, thus the bandwidth and signal quality are unable to reach the anticipated standard and the operation of an electronic device would be affected.

Take the Taiwan Patent. NO.M411022 (corresponding to the Application NO.99224684) for example, an electrical connector and fixed terminals are disclosed, two sides of an insulation body are inserted with fixed terminals thereby being able to be soldered with a main circuit board through the fixed terminals, so an objective of fixing the connector on the main circuit board for the purpose of grounding is achieved. The structural design of the above-mentioned electrical connector can be applied in a general electronic device; with the technical development of electronic device, the high-frequency signals are getting relatively faster; however, the above-mentioned electrical connector is very likely to be interfered by signal interference so the bandwidth and signal quality may not reach the anticipated standard and the operation of electronic device would be affected; the above-mentioned connector is unable to be applied in an electronic device which demands high-frequency transmission, such as an I/O port for USB3.0 used as a bridge in an electronic device or a switching bridge for high-frequency transmission used in a high definition LCD.

As such, how to improve the disadvantage of the conventional electrical connector for high-frequency transmission shall be seriously concerned by the skilled people in the art.

### SUMMARY OF THE INVENTION

The present invention is to provide a connector for a flat conductor, which has advantages of providing an enhanced electrical interference prevention thereby being applicable for high-frequency transmission, and the strength of an insulation body thereof being reinforced for preventing the occurrence of breaking

Accordingly, the present invention provides a connector for a flat conductor, which includes an insulation body, a plurality of conductive terminals arranged in the insulation body, a press cover capable of being operated between an open and a close location, an embedded metal unit and two ground secure members disposed at two lateral sides of the insulation body; preferably, the above-mentioned connector further includes an embedded metal piece. The insulation body is formed with an insertion space, each of the conductive terminals is formed with a contact part protruded into the insertion space, wherein and the embedded metal unit and the conductive terminals are correspondingly arranged with an up/down manner, a part of the embedded metal unit is embedded in the upper portion of the insulation body, and the embedded metal unit is in contact with the ground secure members thereby forming an electrical connection. The embedded metal piece and the embedded metal unit are correspondingly arranged with an up/down manner, a part of the embedded metal piece is embedded in the lower portion of the insulation, and the embedded metal piece is in contact with the ground secure members thereby forming an electrical connection.

A detail illustration is that the ground secure members is formed with a base, an insertion part extended from the base and a connection sheet extended from the bottom of the base; the embedded metal unit is formed with a contact sheet protruded outside the insulation body, and the contact sheet is in contact with the connection sheet.

Preferably, the embedded metal unit is formed with an embedded base embedded in the insulation body, and a plurality of elastic abutting sheets bent and extended from the embedded base and protruded outside the insulation body, wherein the contact sheet is bent and extended from two lateral sides of the embedded base and protruded outside the insulation body.

Preferably, the embedded metal piece is formed a protruded part protruded outside the insulation body, and the protruded part is in contact with the connection sheet of the ground secure member.

### BRIEF DESCRIPTION OF DRAWING

FIG. 1 is a perspective exploded view showing the present invention;

FIG. 2 is a perspective view showing the assembly of the present invention;

FIG. 3 is a cross sectional view showing the present invention;

FIG. 4 is a perspective view showing the present invention, wherein the insulation body being removed;

FIG. 5 is a perspective view showing the assembly of the present invention while being viewed from another angle; and

FIG. 6 is another cross sectional view showing the present invention.

### DETAILED DESCRIPTION OF THE INVENTION

A preferred embodiment of the present invention will be described with reference to the drawings.

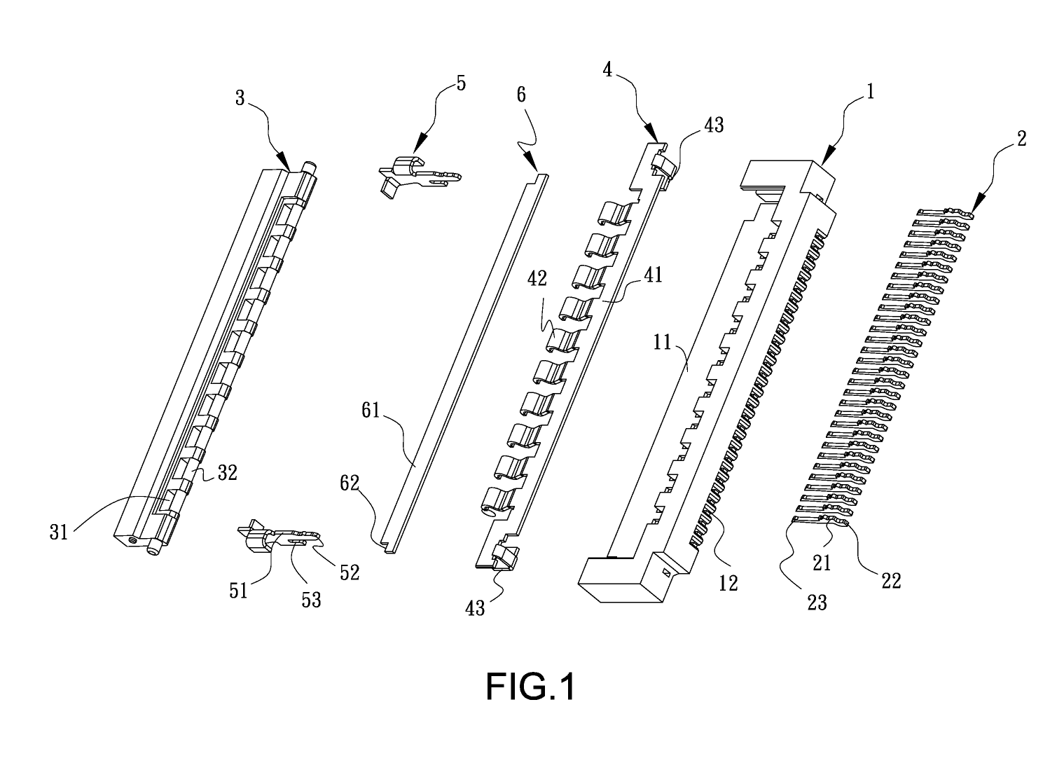

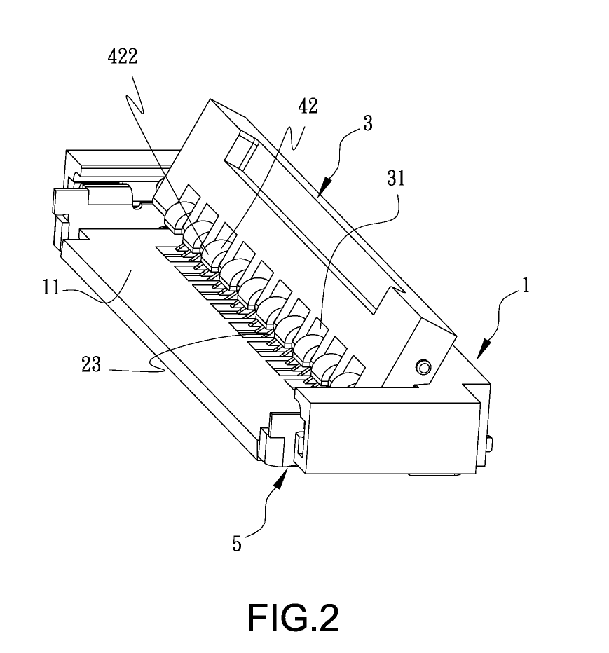

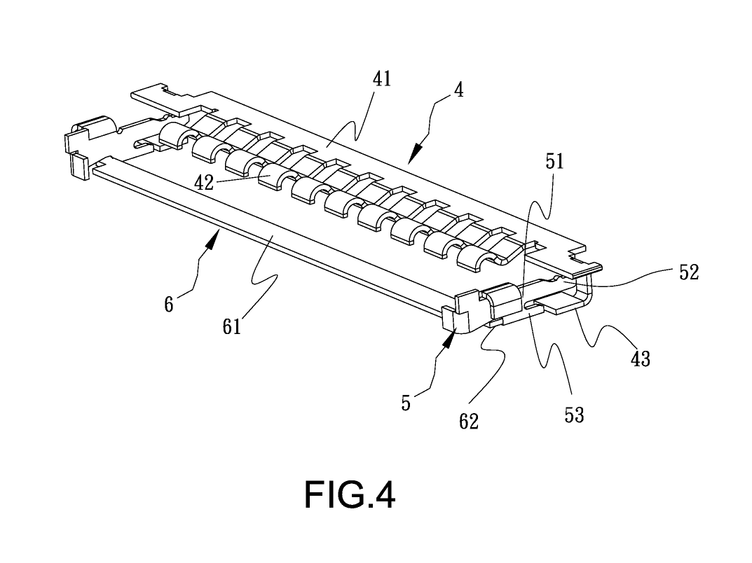

Please refer to from FIG. 1 to FIG. 4, the present invention provides a connector for a flat conductor, which includes an insulation body 1, a plurality of conductive terminals 2, a press cover 3, an embedded metal unit 4, two ground secure members 5 and preferably further includes an embedded metal piece 6.

The insulation body 1 is concavely formed with an insertion space 11 allowing a flat conductor (not shown in figures) to be inserted therein. A plurality of terminal slots 12 arranged in parallel are further formed in the insulation body 1, and each of the terminal slots 12 is communicated with the insertion space 11. Each of the conductive terminals 2 is formed with a fasten part 21, a solder part 22 extended from one end of the fasten part 21 and a contact part 23 extended from the other end of the fasten part 21.

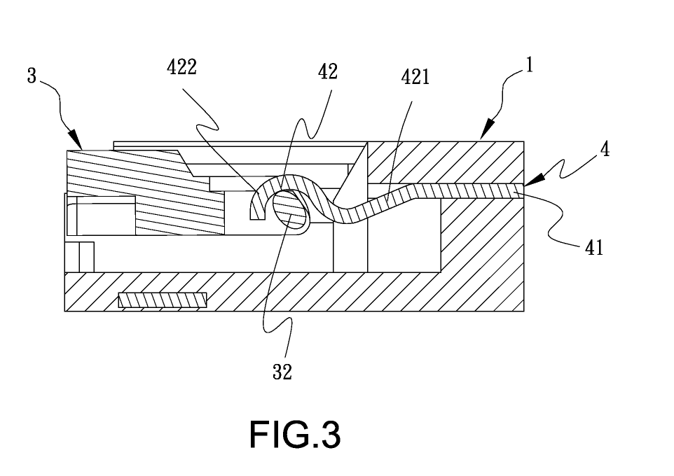

The press cover 3 is formed with a plurality of shaft slots 31, and a rotation shaft 32 formed in a substantially-elliptical status (as shown in FIG. 3) is provided on a lateral wall where the shaft slots 31 are formed.

The embedded metal unit 4 is an elongated metal member formed through a metal plate being punched and bent, and the embedded metal unit 4 is formed with an embedded base 41, a plurality of elastic abutting sheets 42 arranged in parallel and bent and extended from the embedded base 41 and two contact sheets 43 bent and extended from two lateral sides of the embedded base 41. Wherein, each of the elastic abutting sheets 42 includes an elastic segment 421 extended from the embedded base 41 and a pivotal segment 422 extended from the elastic segment 421, and the pivotal segment 422 is formed in a semi-arc shape and pivoted corresponding to the above-mentioned rotation shaft 32.

The ground secure members 5 are respectively formed with a base 51, an insertion part 52 extended from one end of the base 51 and a connection sheet 53 extended from the bottom of the base 51.

The above-mentioned embedded metal piece 6 is formed with an embedded part 61 and two protruded parts 62 extended from two lateral sides of the embedded part 61.

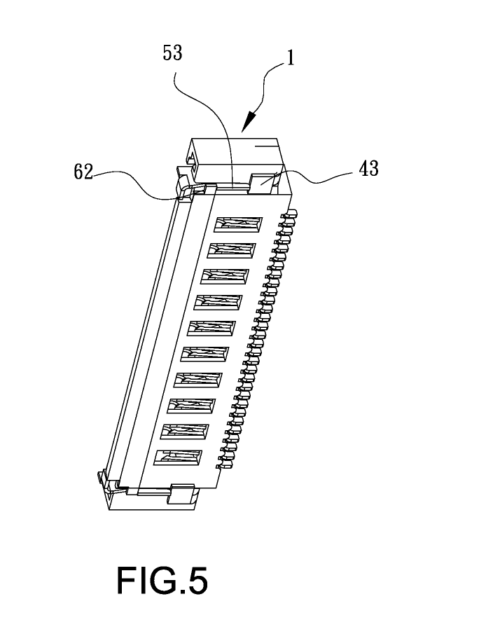

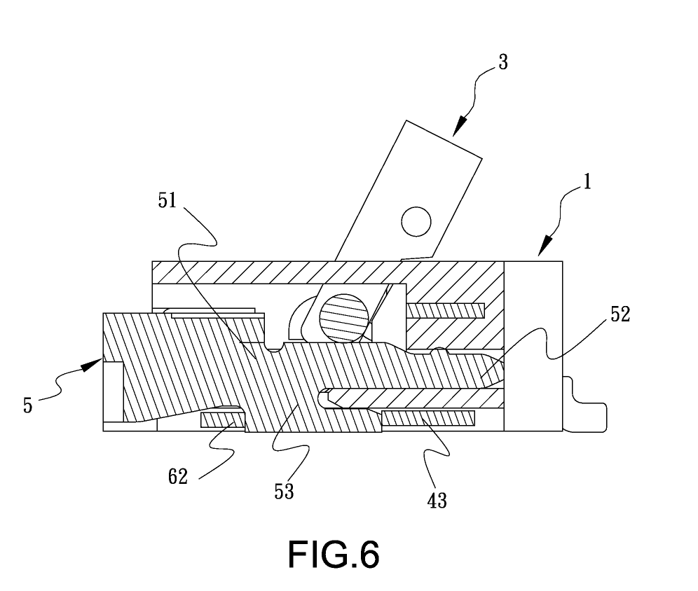

Please refer to FIG. 5 and FIG. 6, the above-mentioned conductive terminals 2 are arranged in parallel and disposed in the insulation body 1, in other words each of the conductive terminals 2 is inserted in the corresponding terminal slot 12 and fastened in the terminal slot 12 through the fasten part 21, the contact part 23 is protruded into the insertion space 11, and the solder part 22 is protruded outside the insulation body 1. The embedded metal unit 4 is embedded in the upper portion of the insulation body 1 with an insert molding means, and the embedded metal unit 4 and the conductive terminals 2 are correspondingly arranged with an up/down manner, and most of the embedded metal unit 4 is embedded in the insulation body 1, in other words the embedded base 41 is embedded in the upper portion of the insulation body 1, and the contact sheets 43 are respectively protruded outside the insulation body 1 and extended towards the bottom of the insulation body 1. The elastic abutting sheets 42 are respectively protruded outside the insulation body 1 and extended towards the insertion space 11 of the insulation body 1.

The above-mentioned embedded metal piece 6 and the embedded metal unit 4 are correspondingly arranged with an up/down manner, and most of the embedded metal piece 6 is embedded in the lower portion of the insulation body 1, wherein the embedded metal piece 6 is embedded in the lower portion of the insulation body 1 with the insert molding means. Substantially, the embedded part 61 of the embedded metal piece 6 is embedded in the lower portion of the insulation body 1, and the protruded parts 62 are protruded outside the insulation body 1.

The above-mentioned press cover 3 is pivotally assembled with the insulation body 1, and capable of being operated between an open and a close location. The elastic abutting sheets 42 of the embedded metal unit 4 are protruded into the shaft slots 31 of the press cover 3, and each of the pivotal segments 422 at the distal end is elastically abutted against the rotation shaft 32, thereby allowing the press cover 3 to be stable pivoted in the insulation body 1.

The above-mentioned ground secure members 5 are disposed at two lateral sides of the insulation body 1, in other words each of the ground secure members 5 is inserted in the insulation body 1 through the insertion part 52 so as to be fastened. When the ground secure members 5 are assembled, the embedded metal unit 4 is in contact with the ground secure members 5 thereby respectively forming an electrical connection. A detail illustration is that the distal end of the contact sheet 43 of the embedded metal unit 4 protruded outside the insulation body 1 is in contact with the connection sheet 53 of the ground secure member 5, thereby achieving an objective of electrical connection. In addition, the embedded metal piece 6 and the ground secure member 5 are in contact thereby forming an electrical connection, a detail illustration is that the lateral end of the protruded part 62 is in contact with the connection sheet 53 thereby achieving the objective of electrical connection.

Based on what has been mentioned above, the embedded metal unit 4 is directly embedded in the upper portion of the insulation body 1, thereby being provided with an electromagnetic shielding effect due to the installation of the embedded metal unit 4 and being able to be in contact with the ground secure members 5 for achieving the electrical connection. As such, the connector is provided with an enhanced effect of preventing electrical interference. Preferably, with the installation of the embedded metal unit 4 and the embedded metal piece 6 which are arranged with an up/down manner and surrounded the whole insulation body 1, the embedded metal unit 4 and the embedded metal piece 6 are both in contact with the ground secure members 5 for establishing the electrical connection thereby achieving an objective of grounding. Accordingly, the connector is provided with advantages of enhancing the capability of preventing electrical interference, such as electrostatic interference, electromagnetic wave interference, impedance matching, noise interference and crosstalk interference between adjacent terminals, so the connector provided by the present invention is able to be applied for high-frequency transmission. Meanwhile, by embedding a metal unit in the insulation body 1, when the total height of the connector is smaller (such as smaller than 1.5 mm), the reinforced strength provided to the insulation body 1 can prevent the occurrence of breaking

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A connector for a flat conductor, including:
an insulation body;
a plurality of conductive terminals, arranged in the insulation body;
a press cover, capable of being operated between an open and a close location;
an embedded metal unit; and
two ground secure members, disposed at two lateral sides of the insulation body;
wherein the insulation body being formed with an insertion space, each of the conductive terminals being formed with a contact part protruded into the insertion space, the embedded metal unit and the conductive terminals being correspondingly arranged with an up/down manner, a part of the embedded metal unit being embedded in the upper portion of the insulation body, and the embedded metal unit being in contact with the ground secure members thereby forming an electrical connection.

2. The connector for a flat conductor according to claim 1, further including an embedded metal piece, wherein the embedded metal piece and the embedded metal unit are correspondingly arranged with an up/down manner, and a part of the embedded metal piece is embedded in the lower portion of the insulation body, and the embedded metal piece is in contact with the ground secure members thereby forming an electrical connection.

3. The connector for a flat conductor according to claim 2, wherein the ground secure members are respectively formed with a base, an insertion part extended from the base and inserted in the insulation body and a connection sheet extended from the bottom of the base; the embedded metal unit is formed with a contact sheet protruded outside the insulation body, and the contact sheet is in contact with the connection sheet thereby forming an electrical connection.

4. The connector for a flat conductor according to claim 3, wherein the embedded metal unit is formed with an embedded base embedded in the insulation body and a plurality of elastic abutting sheets bent and extended from the embedded base and protruded outside the insulation body, wherein the contact sheet is bent and extended from two lateral sides of the embedded base and protruded outside the insulation body; and the press cover is formed with a plurality of shaft slots, and a rotation shaft is provided on a lateral wall where the shaft slots are formed, and the distal ends of the elastic abutting sheets are elastically abutted against the rotation shaft.

5. The connector for a flat conductor according to claim 3, wherein the embedded metal piece is formed a protruded part protruded outside the insulation body, and the protruded part is in contact with the connection sheet of the ground secure members thereby forming an electrical connection.

6. The connector for a flat conductor according to claim 3, wherein the embedded metal piece is formed with an embedded part embedded in the insulation body, and the protruded part is extended from two lateral sides of the embedded part.
